(19) United States
(12) Patent Application Publication
(10) Pub. No.: US 2019/0301528 A1
(43) Pub. Date: Oct. 3, 2019

(54) SLIDING MEMBER AND PRODUCTION METHOD THEREFOR

(71) Applicants: TOYOTA MOTOR EAST JAPAN, INC., Kurokawa-gun (JP); TOYOTA JIDOSHA KABUSHIKI KAISHA, Toyota-shi (JP); Macoho co., Ltd., Nagaoka City (JP)

(72) Inventors: Ryo KOIKE, Kurokawa-gun (JP); Kazuyoshi MANABE, Toyota-shi (JP); Sachito MATSUBARA, Nagaoka City (JP); Masayoshi OGATA, Nagaoka City (JP)

(73) Assignees: TOYOTA MOTOR EAST JAPAN, INC., Kurokawa-gun (JP); TOYOTA JIDOSHA KABUSHIKI KAISHA, Toyota-shi (JP); Macoho co., Ltd., Nagaoka City (JP)

(21) Appl. No.: 16/365,974

(22) Filed: Mar. 27, 2019

(30) Foreign Application Priority Data
Mar. 28, 2018 (JP) 2018-062107

(51) Int. Cl. F16C 33/12; C21D 7/06; C10M 125/04; C10M 135/18; F16C 33/04; F16C 33/10

(52) U.S. Cl. CPC F16C 33/121; C21D 7/06; C10M 125/04; C10M 135/18; F16C 33/043; F16C 2223/08; F16C 33/109; C10N 2240/02; C10M 2219/068; C10N 2210/06; F16C 2204/60; F16C 33/127

(57) ABSTRACT

A problem is to provide a sliding member capable of easily improving friction characteristics, and a production method therefor. A solution is a sliding member 10, wherein a sliding portion 11 is formed of a metallic material, and the sliding member 10 has, on a surface of the sliding portion 11, a Cr-containing modified layer 12 formed by blasting a shot media containing Cr as a composition. The sliding member 10 slides under an environment of a lubricant containing Mo as an additive, in which active Cr exposed on the surface by sliding accelerates decomposition reaction of the additive contained in the lubricant to form a molybdenum disulfide-containing film having low friction on the surface of the sliding portion 11.

### TECHNICAL FIELD

The present invention relates to a sliding member having excellent friction characteristics and a production method therefor.

### BACKGROUND ART

A sliding member such as a gear used in an automobile or the like is required to have high fatigue strength. In particular, from needs for higher output power and size reduction of engines in recent years, a load applied to the sliding member has been increasing, and further improvement in fatigue strength has been required. As a method for improving such fatigue strength, for example, a technology on hardening a surface by shot peening processing, and simultaneously generating high compressive residual stress thereon is known.

In addition, the sliding member such as the gear is also required to have reduced friction and improved wear resistance, and methods for improving these characteristics have also been reported in various manners so far. For example, Patent Literature 1 describes that shot peening processing is performed by using a shot material coated with a solid lubricant, whereby a hard modified layer is formed on the surface, and simultaneously a solid lubrication coating is formed thereon. According to this art, friction can be reduced and wear resistance can be improved by the modified layer and the solid lubrication coating thereon.

Patent Literature 2 describes that hard chrome plating is applied onto a surface of matrix metal, and simultaneously fine particle shot peening processing is performed onto a hard chrome plating layer formed by the hard chrome plating, whereby fine cracks in the hard chrome plating layer can be reduced. According to this art, hardness of the hard chrome plating layer on the surface is improved, the wear resistance is improved, and the friction is reduced.

Patent Literature 3 describes that a large number of fine concave portions are formed on a surface of a matrix material by shot peening, and then solid lubricant particles are shot-sprayed on the surface to form a solid lubricant film on the surface. According to this art, the concave portions function as oil pockets, and simultaneously friction force is reduced due to the solid lubricant film on the surface, and the wear resistance is improved.

Patent Literature 4 describes that an uneven pattern is formed on a sliding surface to fill a solid lubricant into convex portions thereof According to this art, the solid lubricant is prevented from being peeled off, and lubricating properties, the wear resistance, and seizure resistance can be secured for a long period of time.

Patent Literature 5 describes that shot peening in which blasting air pressure is optimized is performed onto a gear after carburizing processing, by using shot medias having two kinds of particle diameters to form the gear having excellent wear resistance and pitching strength.

Patent Literature 6 describes a rolling sliding member in which a diamond-like carbon layer is formed on a surface of a matrix material, and this diamond-like carbon layer is formed by stacking a metal layer including chrome (Cr) and the like, a composite layer formed of metal and carbon, and a carbon layer in this order from a side of the matrix material. According to this art, adhesion between the diamond-like carbon layer and the matrix material can be improved, and the diamond-like carbon layer can be prevented from being peeled off even under high contact pressure.

### CITATION LIST

### Patent Literature

Patent Literature 1: JP 2012-247029 A

Patent Literature 2: JP 2007-63654 A

Patent Literature 3: JP 2006-77802 A

Patent Literature 4: JP 2005-325961 A

Patent Literature 5: JP 2014-210294 A

Patent Literature 6: JP 2008-45631 A

### SUMMARY OF INVENTION

### Technical Problem

However, according to the methods described in Patent Literature 1 to 6, such problems have remained that a new step is required, man-hours increase, or price increases, or the methods are unable to be easily performed. In addition, according to the method described in Patent Literature 1 or 3, such a problem has remained that, if a solid lubrication coating is worn out, lubricating action is lost, and therefore durability is concerned.

The present invention has made on the basis of such a problem, and is contemplated for providing a sliding member capable of easily improving friction characteristics and a production method therefor.

### Solution to Problem

A sliding member of the present invention is a member sliding under an environment of a lubricant containing molybdenum (Mo) as an additive, in which a sliding portion is formed of a metallic material, and the sliding member has, on a surface layer portion of the sliding portion, a Cr-containing modified layer formed by blasting a shot media containing Cr as a composition.

A production method for a sliding member according to the present invention is contemplated for producing the sliding member sliding under an environment of a lubricant containing Mo as an additive, and including a modified layer forming step of blasting a shot media containing chrome (Cr) as a composition on a surface of the sliding portion formed of a metallic material to form a Cr-containing modified layer on a surface layer portion of the sliding portion.

### Advantageous Effects of Invention

A sliding member according to the present invention has a Cr-containing modified layer on a surface layer portion of a sliding portion, and therefore active Cr exposed on the surface by sliding accelerates decomposition reaction of an additive contained in a lubricant, and a molybdenum sulfide-containing film having low friction can be formed on the surface of the sliding portion. Accordingly, friction can be reduced, and wear can also be reduced, and seizure or the like can also be suppressed. In addition, surface roughness Ra on the sliding portion is adjusted within the range of 0.03 μm or more and 0.4 μm or less, and therefore the friction can be further reduced.

The production method for the sliding member according to the present invention is configured so as to blast a shot media containing Cr as a composition onto a surface of a sliding portion, and therefore a surface layer portion can be hardened by blasting of the shot media, and simultaneously a dimple serving as an oil pocket can be formed on the surface thereof, and a Cr-containing active modified layer can be easily formed thereon by using the shot media containing Cr. Accordingly, the sliding member according to the present invention can be easily obtained. Further, surface hardening, formation of the dimple, and addition of Cr can be performed in the same step, and therefore the sliding member can be easily formed without adding a new step, and a production process can be simplified.

Further, the production method according to the present invention is configured so as to blast the shot media according to a wet process, or a dry process in a non-oxidizing atmosphere, and therefore activity of Cr contained in the modified layer can be enhanced, and a higher effect can be obtained.

### BRIEF DESCRIPTION OF DRAWINGS

FIG. 1 is a schematic view showing a configuration of a surface layer portion of a sliding portion of a sliding member according to one embodiment of the present invention.

FIG. 2 is a schematic view for describing action of a surface layer portion during sliding in the sliding portion of the sliding member shown in FIG. 1.

FIG. 3 is a characteristics diagram showing a friction coefficient in comparison between Example 1-1 and Comparative Example 1-1.

FIG. 4 is a characteristics diagram showing a friction coefficient in comparison between Example 1-2 and Comparative Example 1-2.

FIG. 5 is a characteristics diagram showing wear depth after friction in Example 1-1 and Comparative Example 1-1.

FIG. 6 is a characteristics diagram showing a relationship between surface roughness Ra and a friction coefficient.

### DESCRIPTION OF EMBODIMENTS

Hereinafter, embodiments of the present invention will be described in detail with reference to drawings.

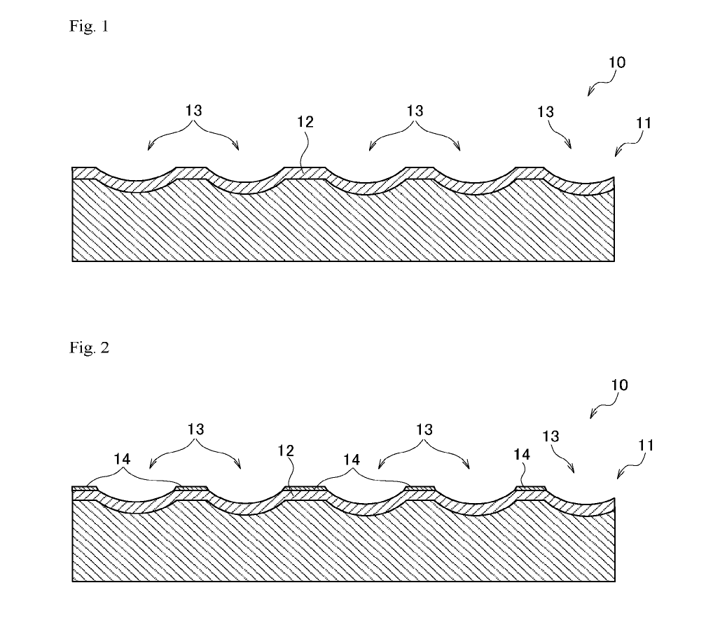

FIG. 1 is a diagram schematically showing a configuration of a surface layer portion in a sliding portion 11 of a sliding member 10 according to one embodiment of the present invention. FIG. 2 is a diagram for describing action of a surface layer portion during sliding in the sliding portion 11 of the sliding member 10. This sliding member 10 slides under an environment of a lubricant containing Mo as an additive, and is preferably used as a gear or a bearing, for example. It should be noted that a term “lubricant containing Mo” means the lubricant to which an additive containing Mo as a constituent element is added, and means the lubricant to which organic molybdenum such as MoDTC is added as the additive, for example. The additive containing Mo as the constituent element in such a manner is used as a friction modifier, for example.

In this sliding member 10, the sliding portion 11 is configured of a metallic material. A term “sliding portion 11” means a part in which members rub against with each other. Examples of the metallic material preferably include steel or cast iron.

The sliding portion 11 has a Cr-containing modified layer 12 formed by blasting a shot media containing Cr as a composition. The modified layer 12 is hardened by blasting the shot media, in which wear resistance is improved. Moreover, in the modified layer 12, a dimple 13 serving as an oil pocket is formed on the surface thereof, in which the sliding portion 11 is configured so as to hold an oil film during sliding. Further, the shot media containing Cr is used in the modified layer 12, whereby Cr is added thereto. The reason why Cr is thus added to the modified layer 12 is that action of Cr accelerates decomposition reaction of the additive containing Mo as the constituent element such as MoDTC which is added to the lubricant, and as shown in FIG. 2, for example, to form a larger amount of a molybdenum disulfide-containing film 14 having low friction on the surface of the modified layer 12. If the molybdenum disulfide-containing film 14 is formed thereon, the friction can be further reduced, the wear can also be reduced, and the seizure or the like can also be suppressed. In addition, Cr forms a passive state on the surface of the modified layer 12, and therefore corrosion resistance is improved.

It should be noted that a mechanism according to which Cr causes decomposition of the additive containing Mo as the constituent element such as MoDTC is estimated as described below. First, if the surface of the sliding portion 11, specifically, an oxide layer (not shown) present on the surface of the modified layer 12 is scraped by the friction caused by sliding, active Cr present in the modified layer 12 is exposed thereon. When the sliding portion 11 is formed of steel or cast iron, active Fe (iron), and as the case may be, active nickel (Ni) or the like is also exposed thereon. In addition, the additive such as MoDTC contained in the lubricant is decomposed by heat, and molybdenum oxysulfide (MoS_{z-x}Oₓ), which is an intermediate product, is present in the lubricant. Ionization tendency of metals is in the order: Cr>Fe≈Mo>Ni, and therefore Cr which is further easily oxidized than Fe deprives molybdenum oxysulfide present in the lubricant of oxygen into chromium oxide. On the other hand, molybdenum oxysulfide which is deprived of oxygen is formed into molybdenum disulfide (MoS₂) to form the molybdenum disulfide-containing film 14 on the surface of the modified layer 12. In the present embodiment, a large amount of Cr is contained in the modified layer 12, and therefore the additive contained in the lubricant is easily decomposed, and the molybdenum disulfide-containing film 14 having low friction is easily formed.

A thickness of the modified layer 12 is preferably 50 nm or more, for example. The reason is that, if the thickness of the modified layer 12 is less than 50 nm, the modified layer 12 is exhausted by wear in a short period of time, and a sufficient effect is unable to be obtained. Surface roughness Ra of the sliding portion 11, namely, surface roughness Ra of the modified layer 12 is preferably within the range of 0.03 μm or more and 0.4 μm or less, and more preferably within the range of 0.04 μm or more and 0.3 or less. The reason is that the friction can be further reduced within this range.

This sliding member 10 can be produced as described below, for example. First, for example, the sliding member 10 is molded, heat-treated, and polished (sliding portion forming step). Next, for example, the shot media containing Cr as the composition is blasted onto the surface of the sliding portion 11 to form the Cr-containing modified layer 12 on the surface layer portion of the sliding portion 11 (modified layer forming step). It should be noted that surface roughness finishing has been performed so far by blasting a shot media mainly containing alumina or silica after the sliding portion forming step. In contrast, in the present embodiment, the surface roughness finishing and addition of Cr are simultaneously performed by blasting a shot media different from the conventional shot media, in place of the conventional surface roughness finishing. Specific examples of the shot media include a Cr-containing steel product.

In the modified layer forming step, the shot media is preferably blasted according to a wet process, or a dry process in a non-oxidizing atmosphere. As the non-oxidizing atmosphere, such a method can be considered as blasting the shot media by compressed air using an inert gas such as nitrogen and argon, for example. The reason is that, according to the dry process, when the shot media is hit onto the surface of the sliding portion 11, Cr is easily oxidized by the heat; however, according to the wet process, a temperature rise when the shot media is hit onto the surface of the sliding portion 11 is suppressed, and simultaneously a liquid film shuts off air, whereby oxidization of Cr can be suppressed and a large amount of active Cr can be allowed to be present in the modified layer 12. Further, the reason is that, even according to the dry process, blasting is performed in the non-oxidizing atmosphere, whereby oxidization of Cr can be suppressed, and a large amount of Cr can be allowed to be present in the modified layer 12.

It should be noted that the wet process is a method of blasting slurry prepared by mixing liquid such as water and oil with the shot media. Specific examples of the non-oxidizing atmosphere according to the dry process preferably include a vacuum atmosphere or an inert gas atmosphere under a gas such as nitrogen and argon. In particular, if the shot media is configured to be blasted according to the wet process, the shot media is easily recovered and reused, and a risk of dust explosion can also be minimized, and therefore such a case is preferable.

In addition, in the modified layer forming step, the shot media is preferably blasted in such a manner that the surface roughness Ra of the sliding portion 11, namely, the surface roughness Ra of the modified layer 12 falls within the range of 0.03 μm or more and 0.4 μm or less. The surface roughness Ra of the sliding portion 11 can be adjusted by a particle diameter of the shot media or air pressure.

Thus, according to the present embodiment, the sliding member 10 has the Cr-containing modified layer 12 on the surface layer portion of the sliding portion 11, and therefore active Cr exposed on the surface by sliding accelerates the decomposition reaction of the additive contained in the lubricant, and the molybdenum disulfide-containing film 14 having low friction can be formed on the surface of the sliding portion 11. Accordingly, the friction can be reduced, the wear can also be reduced, and the seizure or the like can also be suppressed. Further, the surface roughness Ra of the sliding portion 11 is adjusted within the range of 0.03 μm or more and 0.04 μm or less, and therefore the friction can be further reduced.

Further, the shot media containing Cr as the composition is configured to be blasted onto the surface of the sliding portion 11, and therefore the surface layer portion can be hardened by blasting of the shot media, and simultaneously the dimple 13 serving as the oil pocket can be formed on the surface, and the Cr-containing active modified layer 12 can be easily formed thereon by using the shot media containing Cr. Accordingly, the sliding member 10 according to the present embodiment can be easily obtained. In addition, surface hardening and formation of the dimple 13, and addition of Cr can be performed in the same step, and therefore the sliding member 10 can be easily produced without adding a new step, and a production process can be simplified.

Furthermore, the shot media is configured to be blasted according to the wet process, or the dry process under the non-oxidizing atmosphere, and therefore activity of Cr contained in the modified layer 12 can be enhanced and a higher effect can be obtained.

### EXAMPLES

### Examples 1-1 and 1-2, Comparative Examples 1-1 and 1-2

As Examples 1-1 and 1-2, disc-shaped test pieces formed of bearing steel (SUJ2) were arranged, and wet blasting was performed by using a shot media containing Cr in an amount of 15 mass % to 30 mass %. On the above occasion, surface roughness Ra was adjusted by changing air pressure to adjust surface roughness Ra in Example 1-1 to 0.15 μm, and surface roughness Ra in Example 1-2 to 0.3 μm. A ball-on-disc-type friction test was conducted on the test pieces onto which blasting was performed, in a lubricant containing MoDTC in 200 ppm as Mo. As a counterpart material, bearing steel (SUJ2) was applied. A temperature of the lubricant was adjusted to 80° C. keeping constant, a load was adjusted to 10 N, and a sliding speed was adjusted to 0.5 m/s, and a friction coefficient after stabilization was measured.

As Comparative Examples 1-1 and 1-2, the same test pieces as in Examples 1-1 and 1-2 were arranged, blasting was performed, and a friction coefficient was measured in the same manner as in Examples 1-1 and 1-2 for others, except that the shot media was changed to silica. On the above occasion, surface roughness Ra in Comparative Example 1-1 was adjusted to 0.15 μm, and surface roughness Ra in Comparative Example 1-2 was adjusted to 0.3 μm.

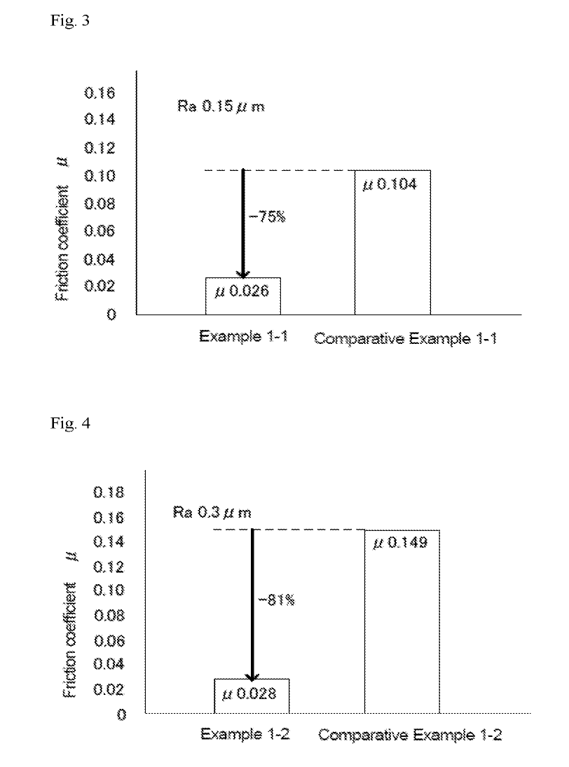

The results obtained are shown in FIG. 3 and FIG. 4. As shown in FIG. 3 and FIG. 4, according to Examples 1-1 and 1-2, the friction coefficient was able to be reduced by as much as 75% to 81%, as compared with Comparative Examples 1-1 and 1-2. More specifically, it was found that, if the shot media containing Cr as the composition is configured to be blasted to form a Cr-containing modified layer 12, friction can be reduced.

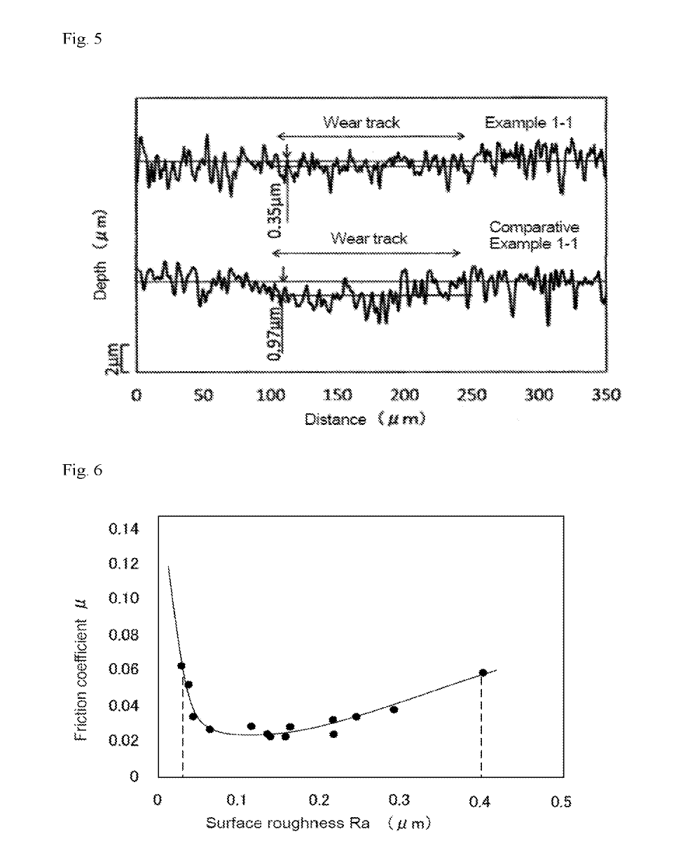

In addition, a reciprocating sliding-type friction test was conducted on the test pieces in Example 1-1 and Comparative Example 1-1 in a lubricant containing MoDTC in 200 ppm as Mo, and a wear depth after friction was measured. As a counterpart material, bearing steel (SUJ2) was applied, and a temperature of a lubricant was adjusted to 80° C. keeping constant, a load was adjusted to 10 N, and a sliding speed was adjusted to 0.5 m/s. The wear depth was investigated on a cross section in a direction perpendicular to a wear track. The results obtained are shown in FIG. 5. As shown in FIG. 5, it was found that, according to the present Example, the wear depth was less, and the wear was able to be reduced by approximately 60%, as compared with Comparative Example 1-1.

Further, hardness on a surface and at a depth up to 50 μm from the surface was investigated on the test pieces in Example 1-1 and Comparative Example 1-1 by measuring Vickers hardness. As a result, no difference was observed between Example 1-1 and Comparative Example 1-1. More specifically, the reason why wear resistance is improved is considered that formation of the Cr-containing modified layer 12 causes acceleration of decomposition reaction of the additive contained in the lubricant, whereby a molybdenum disulfide-containing film having low friction is formed on a surface of a sliding portion.

### Example 2

Blasting was performed on test pieces to measure a friction coefficient in the same manner as in Examples 1-1 and 1-2. On the above occasion, conditions of air pressure were changed from 0.05 MPa to 0.5 MPa to adjust surface roughness Ra, and a relationship between the surface roughness Ra and the friction coefficient was investigated. The results obtained are shown in FIG. 6. As shown in FIG. 6, it was found that the surface roughness Ra is preferably adjusted within the range of 0.03 μm or more and 0.4 μm or less, and more preferably within the range of 0.04 μm or more and 0.3 μm or less.

As described above, the present invention has been described according to the embodiments, but the present invention is not limited to the above-described embodiments, and can be modified in various manners.

### REFERENCE SIGNS LIST

10: Sliding member; 11: sliding portion; 12: modified layer; 13: dimple; 14: film

1. A sliding member sliding under an environment of a lubricant containing molybdenum (Mo) as an additive, wherein
a sliding portion is formed of a metallic material; and
the sliding member has, on a surface layer portion of the sliding portion, a Cr-containing modified layer formed by blasting a shot media containing chrome (Cr) as a composition.

2. The sliding member according to claim 1, wherein surface roughness Ra of the sliding portion is within a range of 0.03 μm or more and 0.4 μm or less.

3. The sliding member according to claim 1, wherein the sliding member is a gear or a bearing.

4. A production method for a sliding member sliding in an environment of a lubricant containing molybdenum (Mo) as an additive, comprising:
a modified layer forming step of blasting a shot media containing chrome (Cr) as a composition onto a surface of a sliding portion formed of a metallic material to form a Cr-containing modified layer on a surface layer portion of the sliding portion.

5. The production method for the sliding member according to claim 4, wherein a shot media is blasted in such a manner that surface roughness Ra of a sliding portion falls within a range of 0.03 μm or more and 0.4 μm or less in the modified layer forming step.

6. The production method for the sliding member according to claim 4, wherein a shot media is blasted according to a wet process, or a dry process under a non-oxidizing atmosphere in the modified layer forming step.
